(19) United States
(12) Patent Application Publication
(10) Pub. No.: US 2007/0212454 A1
(43) Pub. Date: Sep. 13, 2007

(54) Pouch capable of preventing discolorization perception caused due to pigment deposition from contents

(75) Inventors: Hee-Sung An, Gyeonggi-do (KR); Bu-Hyung Kang, Gyeonggi-do (KR); Woo-Sic Jung, Gyeonggi-do (KR); In-Wook Kim, Seoul (KR)

Correspondence Address: BROWDY AND NEIMARK, P.L.L.C.;624 NINTH STREET, NW, SUITE 300, WASHINGTON, DC, 20001-5303, US

(73) Assignee: Youl Chon Chemical Co., Ltd., Seoul (KR)

(21) Appl. No.: 11/715,989

(22) Filed: Mar. 9, 2007

(30) Foreign Application Priority Data
Mar. 9, 2006 (KR) 10 2006 0022191

(51) Int. Cl. A23B 7/148

(52) U.S. Cl. 426/106

(57) ABSTRACT

Disclosed is a pouch useable in a microwave oven comprising a milk-white film between an outermost layer of the film layers constituting the pouch and a pigment deposition layer formed in the film layers by the pigment infiltration from the contents to be preserved in the pouch, in order to prevent a discoloration perception caused by the pigment deposition.

### BACKGROUND OF THE INVENTION

1. Field of the Invention

The invention relates to a pouch capable of preventing discoloration perception caused due to pigment deposition from contents, and particularly, to a pouch, wherein an original outward appearance of the pouch can be maintained without any perception of discoloration, which is caused as pigments (coloring matters) from food contents to be put in the pouch, such as spice, curry, stir-fried rice and the like, become deposited (or infiltrated) onto film layers constituting the pouch.

2. Description of the Related Art

A retort pouch, in which heat-sterilized contents such as foods are put in a heat-resistant plastic, requires a heat-resistance capable of withstanding the sterilizing process. Further, the retort pouch requires a gas (oxygen or vapor)-barrier property and a lightproof property so that the contents can be preserved.

Following constitutions are known as examples of the conventional pouch.

FIG. 1 is a schematic view showing an example of the pouch constitution.

As shown in FIG. 1, the conventional pouch comprises a CPP (cast poly propylene) film 3 contacting contents 1, a nylon film 5 on the CCP film 3, an aluminum foil 6 on the nylon film 5 and a PET film 7 on the aluminum foil 6.

This pouch is not proper for uses in a microwave oven since it comprises particularly the aluminum foil. Accordingly, required is a pouch without using any aluminum foil so that it is proper for uses in the microwave oven.

FIG. 2 is a schematic view showing another example of the pouch constitution.

In the pouch shown in FIG. 2, a milk-white CPP film 2, which has high opaqueness, directly contacts the contents 1, a nylon film 5 is put on the milk-white CPP film 2, a PET film 7 is put on the nylon film 5, an ink layer 8 is put on the PET film 7 and a transparent vapor-deposition PET film 9 is put on the ink layer 8.

This pouch can be used in the microwave oven since it does not use the aluminum foil. In addition, the contents 1 are hardly visible since the milk-white CCP film 2 having the high opaqueness directly contacts the contents 1.

However, according to this pouch, there are following problems. That is, as time goes by, the pigments (coloring matters) are drained out from the contents 1 and to this end, a pigment deposition layer 4 becomes formed at the parts after the milk-white CPP film 2, i.e., between the milk-white CPP film 2 and the nylon film 5. Therefore, even though it is possible to prevent the contents 1 from being visible by means of the milk-white CCP film 2, the discoloration caused due to the pigment deposition from the contents 1 is inevitably perceived through the light L reflected from the pigment deposition layer 4.

Meanwhile, instead of using the milk-white CPP film 2, there has been suggested a pouch in which white ink is twice applied to the PET film 7 in order to make the contents 1 invisible.

Although such pouch is designed to have opaqueness and color reproducibility, the opaqueness, however, becomes deteriorated as time goes by so that the contents become visible. In addition, the discoloration caused due to the pigment deposition from the contents is still perceived.

In short, the conventional pouches do not adopt the aluminum foil so that they can be used in the microwave oven. Such pouches, however, have problems that the contents thereof become visible as time goes by and the discoloration is perceived due to the pigment deposition from the contents, which makes an exhibition effect of the pouches decreased and even consumers have an aversion to the pouches.

### SUMMARY OF THE INVENTION

Accordingly, an object of the invention is to provide a pouch, wherein the pouch has no problems that the contents become visible and there are caused a decrease of exhibition effect and a consumer's aversion to the pouch due to the discoloration perception resulting from the pigment deposition from the contents, and as well the pouch can be used in a microwave oven by not using an aluminum foil and the pouch has physical properties equivalent or superior to the conventional pouch.

In order to accomplish the above object, there is provided a pouch useable in a microwave oven, the pouch comprising a milk-white film between an outermost layer of the film layers constituting the pouch and a pigment deposition layer formed in the film layers by the pigment infiltration from the contents to be preserved in the pouch, in order to prevent a discoloration perception caused by the pigment deposition.

According to an example of the invention, the pouch preferably comprises a CPP film contacting the contents; a nylon film on the CPP film; a PET film or an OPP film on the nylon film; and a transparent vapor-deposition PET film on the PET film or the OPP film, wherein the nylon film is a milk-white nylon film and/or the PET film or the OPP film on the nylon film is a milk-white PET film or a milk-white OPP film.

According to an example of the invention, an ink layer is preferably formed between the PET film or the OPP film on the nylon film and the transparent vapor-deposition PET film.

According to an example of the invention, the milk-white PET film, the milk-white OPP film or the milk-white nylon film is preferably manufactured by mixing a milk-white pigment resin including titanium dioxide and a PET resin or an OPP resin or a nylon resin and biaxial drawing-extruding the mixture.

According to an example of the invention, a thickness of the milk-white PET film is preferably 12 to 50 μm.

According to an example of the invention, a thickness of the milk-white OPP film is preferably 20 to 50 μm.

According to an example of the invention, a thickness of the milk-white nylon film is preferably 15 to 25 μm.

According to an example of the invention, the CPP film is preferably made of homo-polymer polypropylene.

### BRIEF DESCRIPTION OF THE DRAWINGS

FIG. 1 is a schematic view showing an example of a conventional pouch constitution;

FIG. 2 is a schematic view showing another example of a conventional pouch constitution;

FIG. 3 is a schematic view showing a pouch constitution according to an example of the invention;

FIG. 4 is a schematic view showing a pouch constitution according to another example of the invention;

FIG. 5 is photographs comparing degrees of opaqueness when a plain black film is respectively located behind a pouch (a) of an example 1 of the invention and a pouch (b) of a comparison example;

FIG. 6 is graphs showing spectrograms of pouches according to an example 1 of the invention and a comparison example 3; and

FIG. 7 is photographs showing states after curry sauces are put in a pouch (a) of an example 1 of the invention and a pouch (b) of a comparison example 3.

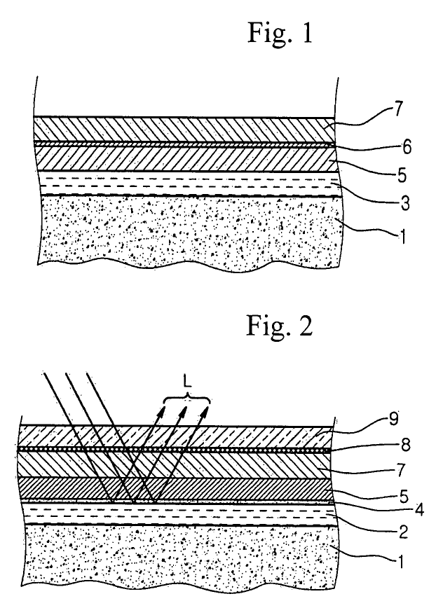

### DETAILED DESCRIPTION OF THE PREFERRED EXAMPLES

Hereinafter, the present invention will be described in detail with reference to the drawings.

According to the invention, instead of treating the film directly contacting the contents with a milk-white color, a milk-white film is provided at the parts after the pigment deposition layer formed in the film layers, i.e., between the pigment deposition layer and the outermost layer of the film layers, in order to fundamentally prevent the discoloration perception caused due to the pigment deposition from the contents. As well, the pouch according to the invention excludes aluminum foil so that it can be used in a microwave oven.

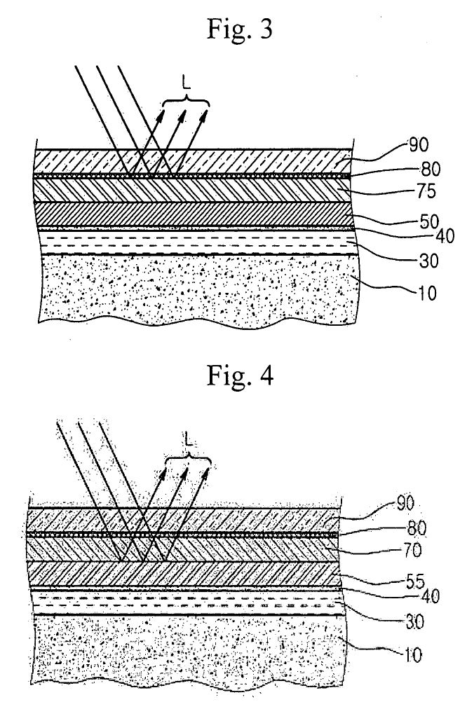

FIG. 3 is a schematic view showing a pouch constitution according to an example of the invention.

In the pouch according to the example, a nylon film 50 is located on a CPP film 30 contacting the contents 10 to be preserved in the pouch and a milk-white PET film 75 or a milk-white OPP film 75, which is treated to have a milk-white color contrary to the conventional PET film or the conventional OPP film used in the pouch film layers, is located on the nylon film 50. An ink layer 80 is located on the milk-white PET film 75 or the milk-white OPP film 75 and a transparent vapor-deposition PET film 90 is located on the ink layer 80.

FIG. 4 is a schematic view showing a pouch constitution according to another example of the invention.

In the pouch according to this example, a milk-white nylon film 55, which is treated to have a milk-white color contrary to the conventional nylon film used in the pouch film layers, is located on a CPP film 30 contacting the contents 10 to be preserved in the pouch, and a PET film 70 or an OPP film 70 is located on the milk-white nylon film 55. An ink layer 80 is located on the PET film 70 or the OPP film 70 and a transparent vapor-deposition PET film 90 is located on the ink layer 80.

In FIGS. 3 and 4, the transparent vapor-deposition PET film 90 serves as a shielding layer. That is, since the contents to be preserved in the retort pouch, such as foods, should be sterilized to have nearly an aseptic state so that it can be preserved at room temperatures for a long time, the pouch should have a shielding property against oxygen, vapor, light and the like. In case of the pouch using the aluminum foil, it has such shielding properties against oxygen, vapor, light and the like. However, since it is difficult to use the foil in a microwave oven, used is a transparent vapor-deposition PET film 90 which can be used in the microwave oven and has the excellent shielding properties against oxygen, vapor, light, and so on. The transparent vapor-deposition PET film is for example a transparent PET film having a silica (SiO₂) vapor-deposited layer or aluminum oxide (Al₂O₃) vapor-deposited layer thereon.

The transparent vapor-deposition PET film 90 is preferably corona-treated. A thickness thereof is preferably 10 to 20 μm, and more preferably 12 μm, in consideration of said shielding property.

Meanwhile, an ink layer 80 may be formed under the transparent vapor-deposition PET film 90, if it is required.

Referring to FIG. 3 again, the milk-white PET film 75 or the milk-white OPP film 75 serves as so called a lower color removing layer, which means hiding a color of its lower layer. Thereby, as shown in FIG. 3, the light L is reflected at the milk-white PET film 75 or the milk-white OPP film 75, so that the discoloration is hardly perceived at the outside of the pouch, although the pigment deposition layer 40 is formed in the film layers by the pigment infiltration from the contents.

In order to manufacture the milk-white PET film 75 or the milk-white OPP film 75, a milk-white pigment resin which includes titanium oxide having stable physical properties is preferably used. That is, the milk-white pigment resin including titanium oxide having high opaqueness and excellent coloration property is mixed with a PET resin or an OPP resin. The mixture is then biaxial drawing-extruded, thereby providing the milk-white PET film 75 or the milk-white OPP film 75.

Meanwhile, among the milk-white PET film-75 and the milk-white OPP film 75, the milk-white PET film 75 has the relatively higher milk-whiteness and opaqueness. Accordingly, the milk-white PET film is more excellent with respect to the purpose of preventing the discoloration perception caused due to the pigment deposition.

Regarding a thickness of the milk-white PET film 75 or the milk-white OPP film 75, the PET film 75 is preferably 12 to 50 μm and the OPP film 75 is preferably 20 to 50 μm, in view of the opaqueness.

The milk-white PET film 75 or the milk-white OPP film 75 has excellent milk-whiteness and opaqueness, so that is can sufficiently prevent any contents from being visible. Further, the film has also excellent color reproducibility when the ink layer 80 is formed.

Furthermore, as described above, even when the pigment deposition layer 40 is inevitably formed, the milk-white PET film 75 or the milk-white OPP film 75 is formed at the parts after the pigment deposition layer 40, which make it possible to prevent the discoloration perception caused due to the pigment deposition from the contents 10. As a result, it is possible to solve the problems that the exhibition effect of a pouch is decreased and customer's aversion to the pouch is caused resulting from the discoloration perception.

The milk-white nylon film 55 is described with reference to FIG. 4. According to the invention, it is possible not only to use the milk-white PET film 75 or the milk-white OPP film 75 but also to use the milk-white nylon film 55, which is treated with a milk-white color contrary to a conventional nylon film, as the lower color removing layer.

Thereby, as shown in FIG. 4, the light L is reflected at the milk-white nylon film 55 having high milk-whiteness and opaqueness. Accordingly, even when the pigment deposition layer 40 from the contents is inevitably formed under the milk-white nylon film 55, it is possible to prevent the discoloration perception, which means that there is no decrease of the exhibition effect of a pouch and customer's aversion to the pouch due to the discoloration perception.

When manufacturing the milk-white nylon film 55, as like the milk-white PET film or the milk-white OPP film, a milk-white pigment resin including titanium oxide having excellent opaqueness and coloration property is mixed with a nylon resin. The mixture is then biaxial drawing-extruded. As the nylon resin, nylon 66 (“PA66”) is preferably used since the nylon 66 has a good tearing property and pin-hole property due to its superior impact-resistance and wear-resistance.

Meanwhile, the milk-white nylon film 55 serves as an impact-resistance layer, and provides the impact-resistance especially for a standing pouch having a high capacity.

The milk-white nylon film 55 has preferably thickness of 15 to 25 μm, in view of the impact-resistance and opaqueness.

Referring to FIGS. 3 and 4, the CPP film 30 serves as a heat-resistance and sealing layer. In the invention, it is preferable to use a cast film of homo-polymer polypropylene as the CPP film 30.

That is, since the retort pouch is sterilized at high temperatures of 110 to 140° C., the heat resistance is required and peeling strength of the laminated part and the sealing part should not be decreased. When the cast film of homo-polymer polypropylene is used as the CPP film, it is possible to provide the heat-resistance and the sealing strength suitable for the retort pouch.

A thickness of the CPP film is preferably 60 to 100 μm, in view of the sealing property and the heat-resistance. Within the range, it is possible to diversely use the CPP film depending on the contents and weights of the pouch.

In the pouch according to the invention, the CPP film contacting the contents is not treated with a milk-white color. Instead, the film layers after the pigment deposition layer, i.e., the PET film or the OPP film or the nylon film is treated with a milk-white color. Herein, if required, all of the PET film or the OPP film and the nylon film may be treated with the milk-white color. Furthermore, in addition to the PET film or the OPP film and the nylon film, an additional milk-white film may further be interposed at the parts after the pigment deposition layer. Further, as long as the milk-white film is provided between the pigment deposition layer and the outmost surface film, the constitution wherein a transparent CPP film treated with a milk-white color is used also falls in a technical scope of the invention. In addition, in the invention, a notch may be further provided to one side of the pouch for the purpose of easy opening.

Hereinafter, experiments regarding the examples and comparison examples will be further described.

<Constitution of Example Films>

A film of an example 1 had a constitution in which layers of a transparent vapor-deposition PET film (12 μm), a milk-white PET film (23 μm), a nylon film (10 μm) and a CPP film (80 μm) were sequentially formed from top to bottom.

A film of an example 2 had a constitution in which layers of a transparent vapor-deposition PET film (12 μm), a milk-white OPP film (30 μm), a nylon film (10 μm) and a CPP film (80 μm) were sequentially formed from top to bottom.

In the examples, a film manufactured by mixing the milk-white pigment resin containing titanium oxide with a PET resin or an OPP resin and then biaxial drawing-extruding the mixture was used for the milk-white PET film or the milk-white OPP film.

As an adhesive to adhere the layers, a two components type polyurethane based adhesive was used. The two components type polyurethane based adhesive comprised a polyurethane based resin as a main component and polyisocyanate as a curing agent and ethyl acetate as a dilution solvent. In the examples, the adhesive comprised solid component of about 30 wt % and the application amount of the adhesive was about 3.5 g/m².

The transparent vapor-deposition PET film and the milk-white PET film (example 1) or the milk-white OPP film (example 2) was adhered with each other by means of the adhesive. While the adhered films were allowed to pass into a lamination roll at about 80° C., the solvent in the adhesive was dried, so that the lamination was made.

Then, the nylon film was adhered to the films by means of the adhesive, which was then allowed to pass into the lamination roll at about 80° C. and the solvent in the adhesive was dried, so that the lamination was made. In addition, the CPP film was adhered to the films with the adhesive, which was then allowed to pass into the lamination roll at about 80° C. and the solvent in the adhesive was dried, so that the lamination was made. As a result, the pouches of the examples were completed.

### <Constitution of Comparison Examples>

A film of a comparison example 1 had a constitution in which layers of a conventional PET film (12 μm), a conventional PET film (12 μm), a nylon film (10 μm) and a CPP film (80 μm) are sequentially formed from top to bottom.

A film of a comparison example 2 had a constitution in which layers of a transparent vapor-deposition PET film (12 μm), white ink layers applied twice, a conventional PET film (12 μm), a nylon film (10 μm) and a CPP film (80 μm) are sequentially formed from top to bottom.

A film of a comparison example 3 had a constitution in which layers of a transparent vapor-deposition PET film (12 μm), a conventional PET film (12 μm), a nylon film (10 μm) and a CPP film (80 μm) are sequentially formed from top to bottom.

In the comparison examples, the respective films were adhered with each other as like those of the examples.

<Opaqueness Test>

For an opaqueness test, a color density tester and a plain black film was prepared.

In the test, the plain black film was closely contacted under pure white parts of the respective pouches according to the examples and the comparison examples, and concentration values of those parts of the respective pouches were measured with the color density tester, so that average values thereof were obtained.

A table 1 shows a measurement result. As a reference for the comparison to the measurement result, a concentration value of pure white A4 paper was 0.11 and a concentration value of the plain black film was 2.10. Accordingly, as the concentration value was closer to 0.11, the “milk-white” opaqueness of the pouches was considered as higher. To this contrary, as the concentration was closer to 2.10, the “milk-white” opaqueness of the pouches was considered as lower.

TABLE 1

| | Concentration value |
|---|---|
| Example 1 | 0.14 |
| Example 2 | 0.19 |
| Comparison example 1 | 1.5 |
| Comparison example 2 | 0.35 |
| Comparison example 3 | 0.15 |

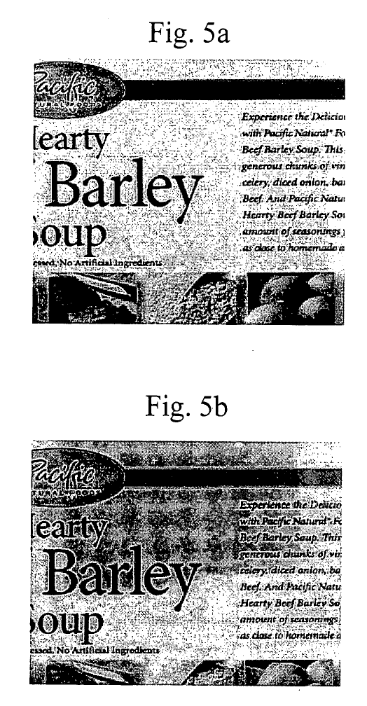

Meanwhile, FIG. 5 is photographs comparing degrees of opaqueness when the plain black film is respectively located behind the pouch (a) of the example 1 and the pouch (b) of the comparison example 2.

As can be seen from FIG. 5, in the case of the pouch (a) of the example 1, the black film at the back part of the pouch was hardly visible. To this contrary, in the case of the pouch (b) of the comparison example 2, the opaqueness was not relatively good, so that the black film at the back part of the pouch was visible.

<Measurement of Discoloration Degree Caused Due to the Pigment Deposition from the Contents>

In order to measure a discoloration degree caused due to the pigment deposition from the contents, the curry sauces were put in the respective pouches of the examples and the comparison examples for 30 days (preserved at room temperatures) as the contents and the white parts (transparent parts in the case of the comparison example 1) were respectively measured with a spectrophotometer.

A table 2 shows a measurement result of color difference before and after the contents were put in the respective pouches of the examples and the comparison examples.

TABLE 2

| | Color difference |
|---|---|
| Example 1 | 0.19 |
| Example 2 | 0.25 |
| Comparison example 1 | 20.92 |
| Comparison example 2 | 16.27 |
| Comparison example 3 | 13.80 |

As can be seen from the table 2, in the case of the pouches of the comparison examples, the color differences were remarkably high. However, in the case of the pouches of the examples, the color differences were relatively very low. This means that the discoloration caused by the pigment deposition was hardly perceived.

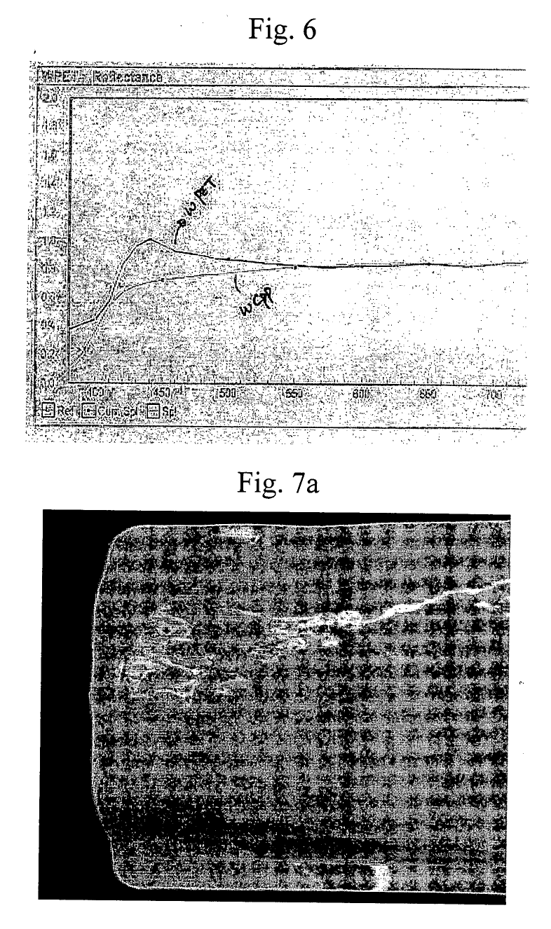

Meanwhile, FIG. 6 is graphs showing spectrograms of pouches according to the example 1 and the comparison example 3. In FIG. 6, the graph of the example 1 was indicated with “W PET” (which means that the milk-white PET film was used) and the graph of the comparison example 3 was indicated with “W CPP” (which means that the milk-white CPP film was used).

As shown in FIG. 6, in the pouch of the example 1, there was a uniform reflectivity at 380˜780 nm, the visible ray ranges. Further, the white color of the pouch was perceived, so that the pouch discoloration due to the pigment deposition from the contents was not perceived.

To the contrary, the reflectivity of the pouch of the comparison example 3 was lowered at the 400˜550 nm (blue color wavelength), so that a yellow or orange color, which is a mixed color of red and green colors, was checked. This clearly means that the pouch discoloration due to the pigment deposition from the contents was perceived.

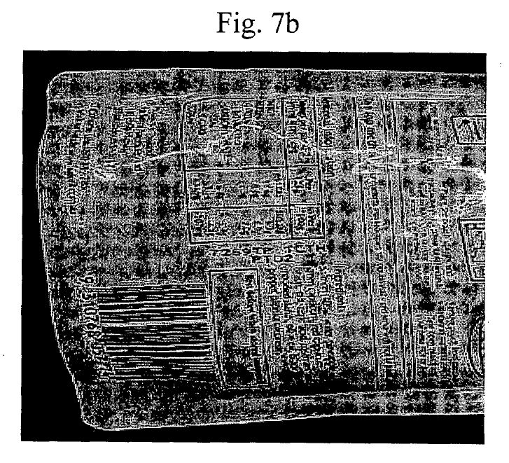

Further, FIG. 7 is photographs showing states after curry sauces were put in the pouch (a) of the example 1 and the pouch (b) of the comparison example 3.

As can be seen from FIG. 7, in the case of the pouch (b) of the comparison example 3, it was possible to confirm with naked eyes that the yellow or orange color appeared along the parts in which the contents were put. However, in the case of the pouch (a) of the example 1, it was not possible to perceive the discoloration even though the contents were put.

### <Test for the Other Physical Properties>

It was possible to confirm that the pouches of the examples had the physical properties equivalent or superior to the physical properties required for the retort pouch.

With respect to the sealing strength, the followings were confirmed: when sealing the pouch at 250° C., while the conventional typical pouches had the strength of about 3.5 kg/15 mm, all the pouches of the examples met the criterion of 5 kg/15 mm before the sterilization.

With respect to the heat-resistance of the pouch, which is required during the retort sterilizing process using the hydrothermal or vapor of 120° C. or higher, the pouch of the examples was good.

That is, in the case of the conventional typical pouch, the heat-resistance is considered to be good if the pouch withstands for 20˜40 minutes after it is directly or indirectly contacted to the hydrothermal or vapor of 120˜125° C. (“Withstanding” means that there occurs no deformation or peeling between the laminated layers due to the heat, there occurs no adherence from fusion between the pouch inner surfaces, and there occurs no size deformation due to a shrinkage). The pouches of the examples withstood even for 60 minutes in the process of directly sprinkling the hydrothermal of 130° C. to the pouches.

As described above, the pouch of the invention has excellent opaqueness, the contents of the pouch are not visible and the discoloration due to the pigment deposition from the contents is not nearly perceived. Therefore, in the pouch of the invention, there is no such problem of the decrease of the exhibition effect of a pouch and the customer's aversion to the pouch.

In addition, the pouch of the invention has the physical properties equivalent or superior to those of the conventional pouch, such as sealing strength, heat-resistance and the like, so that the pouch does not cause any problem when it is actually distributed and used. Further, the pouch of the invention has the excellent shielding property against the oxygen, vapor and the like.

In short, the pouch according to the invention does not basically use the aluminum foil, so that it can be used in the microwave. Further, the pouch has no problems that the contents are visible, the exhibition effect of the pouch is decreased and a consumer's aversion to the pouch is caused by the discoloration perception due to the pigment deposition of the contents. Furthermore, the pouch has the physical properties equivalent or superior to those of the conventional pouch.

What is claimed is:

1. A pouch useable in a microwave oven, comprising a milk-white film between an outermost layer of the film layers constituting the pouch and a pigment deposition layer formed in the film layers by the pigment infiltration from the contents to be preserved in the pouch, in order to prevent a discoloration perception caused by the pigment deposition.

2. The pouch according to claim 1, wherein the pouch comprises a CPP film contacting the contents; a nylon film on the CPP film; a PET film or an OPP film on the nylon film; and a transparent vapor-deposition PET film on the PET film or the OPP film, the PET film or the OPP film on the nylon film being a milk-white PET film or a milk-white OPP film.

3. The pouch according to claim 2, wherein an ink layer is formed between the PET film or the OPP film on the nylon film and the transparent vapor-deposition PET film.

4. The pouch according to claim 2, wherein the milk-white PET film or the milk-white OPP film is manufactured by mixing a milk-white pigment resin including titanium dioxide and a PET resin or an OPP resin and biaxial drawing-extruding the mixture.

5. The pouch according to claim 2, wherein a thickness of the milk-white PET film is 12 to 50 μm.

6. The pouch according to claim 2, wherein a thickness of the milk-white OPP film is 20 to 50 μm.

7. The pouch according to claim 2, wherein the CPP film is made of homo-polymer polypropylene.

8. The pouch according to claim 1, wherein the pouch comprises a CPP film contacting the contents; a nylon film on the CPP film; a PET film or an OPP film on the nylon film; and a transparent vapor-deposition PET film on the PET film or the OPP film, the nylon film being a milk-white nylon film.

9. The pouch according to claim 8, wherein an ink layer is formed between the PET film or the OPP film on the nylon film and the transparent vapor-deposition PET film.

10. The pouch according to claim 8, wherein the milk-white nylon film is manufactured by mixing a milk-white pigment resin including titanium dioxide and a nylon resin and biaxial drawing-extruding the mixture.

11. The pouch according to claim 8, wherein a thickness of the milk-white nylon film is 15 to 25 μm.

12. The pouch according to claim 8, wherein the CPP film is made of homo-polymer polypropylene.

13. The pouch according to claim 1, wherein the pouch comprises a CPP film contacting the contents; a nylon film on the CPP film; a PET film or an OPP film on the nylon film; and a transparent vapor-deposition PET film on the PET film or the OPP film, the nylon film being a milk-white nylon film, and the PET film or the OPP film on the nylon film being a milk-white PET film or a milk-white OPP film.

14. The pouch according to claim 13, wherein an ink layer is formed between the PET film or the OPP film on the nylon film and the transparent vapor-deposition PET film.

15. The pouch according to claim 13, wherein the milk-white PET film or the milk-white OPP film or the milk-white nylon film is manufactured by mixing a milk-white pigment resin including titanium dioxide and a PET resin or an OPP resin or a nylon resin and biaxial drawing-extruding the mixture.

16. The pouch according to claim 13, wherein a thickness of the milk-white PET film is 12 to 50 μm.

17. The pouch according to claim 13, wherein a thickness of the milk-white OPP film is 20 to 50 μm.

18. The pouch according to claim 13, wherein a thickness of the milk-white nylon film is 15 to 25 μm.

19. The pouch according to claim 13, wherein the CPP film is made of homo-polymer polypropylene.
